(19) United States
(12) Patent Application Publication
(10) Pub. No.: US 2023/0004452 A1
(43) Pub. Date: Jan. 5, 2023

(54) METHOD AND DEVICE FOR ANALYZING FEATURE-LEVEL USAGE OF APP

(71) Applicant: Korea Advanced Institute of Science and Technology, Daejeon (KR)

(72) Inventors: Sung-Ju Lee, Daejeon (KR); Hyunsung Cho, Daejeon (KR); Donghwi Kim, Daejeon (KR); Daeun Choi, Daejeon (KR)

(21) Appl. No.: 17/852,852

(22) Filed: Jun. 29, 2022

(30) Foreign Application Priority Data
Jun. 29, 2021 (KR) 10-2021-0084961

(51) Int. Cl. G06F 9/54; G06F 11/34

(52) U.S. Cl. CPC G06F 9/542; G06F 11/3438; G06F 40/20

(57) ABSTRACT

Provided are a method and a device for analyzing feature-level usage of an app.

The method may include: detecting an event generated in a user terminal; extracting a user interface component for the detected event as a layout element; detecting a feature of the app based on the extracted layout element; and analyzing a usage at the detected feature-level.

### CROSS-REFERENCE TO RELATED APPLICATION

This application claims priority to and the benefit of Korean Patent Application No. 10-2021-0084961 filed in the Korean Intellectual Property Office on Jun. 29, 2021, the entire contents of which are incorporated herein by reference.

### BACKGROUND OF THE DISCLOSURE

### (a) Field of the Disclosure

The present disclosure relates to a method and a device for analyzing a feature-level usage of apps.

### (b) Description of the Related Art

Smart phones are capable of additionally installing various applications to flexibly provide various features of the user's choice. A smart phone user may access software markets, for example, app stores to download an app of the user's choice. As a distribution rate of the smart phones is increased and a time spent to use smart phones that provide various features utilized throughout the day significantly increases, problems of smart phone overuse or smart phone addiction have emerged.

Excessive use of smart phones not only causes symptoms such as cessation and tolerance for smart phone use, disturbances in daily life, and orientation to virtual words, but also affects physical health such as sleep disorder, deteriorated vision function, and turtle neck syndrome. The problems are so recognizable that studies for measuring healthy smart phone use are being actively conducted.

The above information disclosed in this Background section is only for enhancement of understanding of the background of the disclosure, and therefore it may contain information that does not form the prior art that is already known in this country to a person of ordinary skill in the art.

### SUMMARY OF THE DISCLOSURE

The present disclosure has been made in an effort to provide a method and a device for analyzing a usage amount, a use form, and a use pattern of the smart phone in the feature-level of the app which is more subdivided than in the units of apps.

A method for analyzing feature-level usage of an app according to an example embodiment of the present disclosure may include: detecting an event generated in a user terminal; extracting a user interface component for the detected event as a layout element; detecting a feature of the app based on the extracted layout element; and analyzing a usage at the detected feature-level.

In some example embodiments of the present disclosure, the method further includes selecting a feature detector for an app in use in the user terminal, and detecting the feature of the app includes detecting the feature of the app using the selected feature detector.

In some example embodiments of the present disclosure, the app includes a first app and a second app, and selecting a feature detector includes: ending the use of a feature detector for the first app and starting the use of a feature detector for the second app when a session of the first app ends and a session of the second app starts.

In some example embodiments of the present disclosure, extracting a user interface component for the detected event as a layout element includes: storing information about the user interface component as the layout element with a tree structure.

In some example embodiments of the present disclosure, detecting the feature of the app includes: detecting an element selected while traversing the layout element with the tree structure; determining view information by analyzing the element; determining content information by analyzing a text associated with view information; and detecting the feature based on a combination of the view information and the content information.

In some example embodiments of the present disclosure, determining view information includes: determining the view information according to a location, a size or index information of the selected element.

In some example embodiments of the present disclosure, determining view information includes: determining view information according to a class name of a root view for the selected element.

In some example embodiments of the present disclosure, determining view information includes: determining the view information according to whether there are content description and a text for the selected element.

In some example embodiments of the present disclosure, determining view information includes: determining the view information according to viewIdResourceName information for the selected element.

In some example embodiments of the present disclosure, detecting an event includes: detecting at least one of a scroll event, a click event, a focus event, a window transition event, and a window state transition event.

A device for analyzing feature-level usage of an app according to an example embodiment of the present disclosure includes: an event detection module which detects an event generated in a user terminal; a layout element extraction module which extracts a user interface component for the detected event as a layout element; a layout element based feature detection module which detects a feature of the app based on the extracted layout element; and a feature-level usage analysis module which analyzes a usage at the detected feature level.

In some example embodiments of the present disclosure, the device may further include: a feature detector selection module which selects a feature detector for an app in use in the user terminal and the layout element based feature detection module may detect the feature of the app using the selected feature detector.

In some example embodiments of the present disclosure, the app includes a first app and a second app, and the feature detector selection module ends the use of a feature detector for the first app and starts the use of a feature detector for the second app when a session of the first app ends and a session of the second app starts.

In some example embodiments of the present disclosure, the layout element extraction module stores information about the user interface component as the layout element with a tree structure.

In some example embodiments of the present disclosure, the layout element based feature detection module detects an element selected while traversing the layout element with the tree structure, determines view information by analyzing the element, determines content information by analyzing a text associated with view information, and detects the feature based on a combination of the view information and the content information.

In some example embodiments of the present disclosure, the layout element based feature detection module determines the view information according to a location, a size or index information of the selected element.

In some example embodiments of the present disclosure, the layout element based feature detection module determines view information according to a class name of a root view for the selected element.

In some example embodiments of the present disclosure, the layout element based feature detection module determines the view information according to whether there is content description and a text for the selected element.

In some example embodiments of the present disclosure, the layout element based feature detection module determines the view information according to viewIdResourceName information for the selected element.

In some example embodiments of the present disclosure, the event detection module detects at least one of a scroll event, a click event, a focus event, a window transition event, and a window state transition event.

According to an example embodiment of the present disclosure, a usage, use form, or use pattern of the smart phone is analyzed at a feature level of the app to analyze which app is used by the user for a long time, which app is frequently used in the app-unit analysis of the related art. Further, even in one app, which feature is spent a lot of time by the user and which feature is frequently used are also specifically analyzed. Simultaneously, when the data for the analysis is collected, the personal information protection issue may not be caused.

Further, according to the example embodiment of the present disclosure, such detailed analysis is executed as a background service without going through an artificial analysis process by experts to automatically collect a usage, a use form, or a use pattern of a smart phone to ensure the reliable analysis data in a short time.

Further, according to the example embodiment of the present disclosure, since an interface which is capable of customizing a feature-level of an app to be analyzed is provided to a developer or an analyzer, when an app which is newly used is analyzed in the feature level, the method and the device for analyzing a feature-level of an app may easily set the analysis policy without going through complicated coding tasks so that the usability and the usage convenience may be ensured.

### BRIEF DESCRIPTION OF THE DRAWINGS

FIG. 1 is a block diagram for explaining a device for analyzing a feature-level usage of an app according to an example embodiment of the present disclosure.

FIG. 2 is a view for explaining an example implementation example for a device for analyzing a feature-level usage of an app according to an example embodiment of the present disclosure.

FIG. 3 is a flowchart for explaining a method for analyzing a feature-level usage of an app according to an example embodiment of the present disclosure.

FIGS. 4 to 7 are views for explaining some example implementation examples of a device and a method for analyzing a feature-level usage of an app according to an example embodiment of the present disclosure.

FIG. 8 is a view for explaining an example applied example of a device and a method for analyzing a feature-level usage of an app according to an example embodiment of the present disclosure.

FIG. 9 is a block diagram for explaining a computing device for implementing a method and a device for analyzing a feature-level usage of an app according to an example embodiment of the present disclosure.

### DETAILED DESCRIPTION OF THE EMBODIMENTS

Hereinafter, the present disclosure will be described more fully hereinafter with reference to the accompanying drawings, in which example embodiments of the disclosure are shown. As those skilled in the art would realize, the described embodiments may be modified in various different ways, all without departing from the spirit or scope of the present disclosure. Accordingly, the drawings and description are to be regarded as illustrative in nature and not restrictive. Like reference numerals designate like elements throughout the specification.

In the specification and the claims, unless explicitly described to the contrary, the word “comprise” and variations such as “comprises” or “comprising”, will be understood to imply the inclusion of stated elements but not the exclusion of any other elements.

In addition, the terms “-er”, “-or” and “module” described in the specification mean units for processing at least one function and operation and can be implemented by hardware components or software components and combinations thereof.

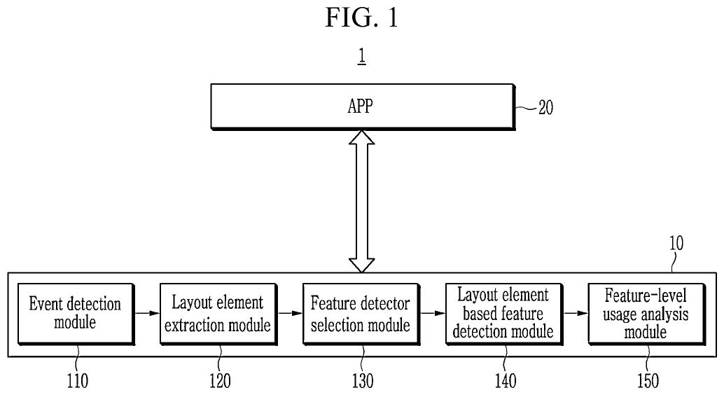

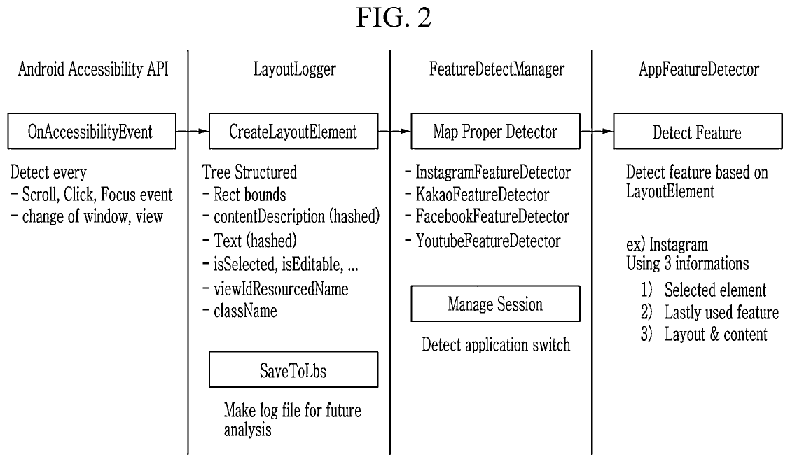

FIG. 1 is a block diagram for explaining a device for analyzing a feature-level usage of an app according to an example embodiment of the present disclosure and FIG. 2 is a view for explaining an example implementation example for a device for analyzing a feature-level usage of an app according to an example embodiment of the present disclosure.

In the related art, in order to identify a user's smart phone usage state, a usage time and a using frequency were tracked in the unit of apps. However, according to the app-level tracking method, it is difficult to analyze how long and which sub features are used by the user in the app. In order to provide a healthy smart phone usage environment, it is necessary to identify the usage or the usage pattern of the user in the unit which is subdivided more than the app level. However, the app does not provide a feature for tracking the user's usage and usage pattern for every feature.

In order to solve this problem, a device 10 for analyzing a feature-level usage of an app 20 according to an example embodiment of the present disclosure detects various features of the app using layout information of the app 20 and tracks the user's feature level usage or feature level use pattern at the detected feature level to provide fine-grained analysis for the smart phone usage. Further, when the data is collected for the analysis, the device 10 for analyzing a feature-level usage of an app 20 may provide a feature for preventing a personal information protection issue (privacy issue).

Referring to FIG. 1, the device 10 for analyzing a feature-level usage of an app 20 may be included in a computing device 1. Here, the device 10 for analyzing a feature-level usage of an app 20 may be implemented by a hardware device, a combination of a hardware device and software, or software. The device 10 for analyzing a feature-level usage of an app 20 may be driven or executed together with the app 20 executed in the computing device 1 to analyze the app usage.

In the present example embodiment, the device 10 for analyzing a feature-level usage of an app 20 includes an event detection module 110, a layout element extraction module 120, a feature detector selection module 130, a layout element based feature detection module 140 and a feature-level usage analysis module 150. Referring to FIG. 2 together, the event detection module 110, the layout element extraction module 120, the feature detector selection module 130 and the layout element based feature detection module 140 of FIG. 1 may correspond to android accessibility API (Application Programming Interface), “LayoutLogger”, “FeatureDetectManager” and “AppFeatureDetector” of FIG. 2, respectively.

The event detection module 110 may detect an event generated in a user terminal. Here, the user terminal may be a smart phone. The scope of the present disclosure is not limited thereto so that the user terminal may include an arbitrary computing device which installs and executes an app or an application to implement functions, such as a tablet computer, a laptop computer, a desktop computer, and a smart watch.

The event generated in the user terminal may be various types of events which are generated while the user interacts with a smart phone or generated while the app is running on the smart phone, such as a scroll event, a click event, a focus event, a window transition event, and a window state transition event.

The event detection module 110 may be implemented by an accessibility service which is provided through an android accessibility API to detect the event generated in the user terminal. The event generated in the user terminal, for example, may be analyzed by means of “OnAccessibilityEvent” method of “AccessibilityService” class of the accessibility service.

The layout element extraction module 120 extracts a user interface component for the event detected by the event detection module 110 as a layout element.

Examples of the user interface component for the detected event may include an element selected from a menu bar, a layout of a screen, a class name of activity/components, a window ID, previous features, a text (preferably, hashed text), content description (preferably, hashed content description), rectangular bounds (Rect bounds), selected element (isSelected), editable elements (isEditable), android view resource ID and name (viewIdResourceName). Of course, the user interface component for the detected event is not limited to those mentioned above and may include an arbitrary element which is displayed on the user terminal to interact with the user and generate an event.

The layout element extraction module 120 may store information about a user interface component for the detected event as described above as a layout element having a tree structure. Such a task may be performed by “CreateLayoutElement” method which is implemented in “LayoutLogger” of FIG. 2.

One of the reasons for adopting the tree structure to configure the layout element is to increase the efficiency when the layout element based feature detection module 140 performs a task of searching and analyzing the layout element. However, the scope of the present disclosure is not necessarily limited thereto and for example, the layout element may be stored as another arbitrary data structure such as a linked list.

Particularly, in consideration of a privacy protection issue, the layout element extraction module 120 hashes a text displayed on the screen and data for content description or performs a process for minimizing collected data by extracting only a keyword which is absolutely necessary for the analysis.

In the meantime, even though the type or a screen size of the user terminal is different, in order to ensure the analysis reliability, when the feature is detected, the layout element extraction module 120 may not use information about the size of the user interface component or minimize the usage proportion thereof. For example, instead of information about the terminal type or the screen size which may vary depending on the user, information about the class name determined during the development process is mainly used to ensure the operation reliability in spite of the deviation of the usage environment between users.

Further, the layout element extraction module 120 may use a hash map which matches the detected feature and a window ID to prevent interruption of tracking one feature session due to the unexpected layout detection. Accordingly, even though the unexpected layout appears for reasons such as updating of the app interface, if the window ID is the same, it is determined that the detected feature is also the same so that the operation stability may be ensured.

In some example embodiments of the present disclosure, “SaveToLbs” of FIG. 2 may be implemented in the layout element extraction module 120 and this may produce a log file which may be used for the analysis in the future.

The feature detector selection module 130 selects a feature detector for an app which is being used in the user terminal.

The feature detector selection module 130 may be performed by “MapProperDetector” method implemented in “FeatureDetectManager” of FIG. 2 and the feature provided to the user is different for every app so that a policy for how to analyze the layout element provided from the event detection module 110 and the layout element extraction module 120 is defined.

For example, when an app which is being used in the user terminal is Instagram, the “MapProperDetector” method may provide “InstagramFeatureDetector” including a policy optimized for a feature provided from the Instagram. Similarly, when the app which is being used in the user terminal is Kakaotalk, the “MapProperDetector” method provides “KakaoFeatureDetector” including a policy optimized for a feature provided from the Kakaotalk, when the app which is being used in the user terminal is Facebook, provides “FacebookFeatureDetector” including a policy optimized for a feature provided from the Facebook, and when the app which is being used in the user terminal is Youtube, provides “YouTubeFeatureDetector” including a policy optimized for a feature provided from YouTube. As described above, the policy for every app provided from the feature detector selection module 130 may be utilized as a reference for analysis in the layout element based feature detection module 140 and the feature-level usage analysis module 150.

Further, when an app which is being used in the user terminal is switched from a first app to a second app, that is, a session of the first app ends and a session of the second app starts, the feature detector selection module 130 ends the usage of the feature detector for the first app and starts the usage of the feature detector for the second app. For example, when the session of the Instagram app ends and the session of the Facebook starts in the user terminal, the feature detector selection module 130 ends the usage of the feature detector for the Instagram app “InstagramFeatureDetector” and starts the usage of the feature detector for the Facebook app “FacebookFeatureDetector”.

In some example embodiments of the present disclosure, “ManageSession” of FIG. 2 may be implemented in the feature detector selection module 130, which may detect the application switch.

The layout element based feature detection module 140 may detect the feature of the application based on the layout element extracted by the layout element extraction module 120. Particularly, the layout element based feature detection module 140 may detect what is the feature of the app which is currently in use. Such a task may be performed by “DetectFeature” method implemented in “AppFeatureDetector” of FIG. 2.

For example, when the app which is being used in the user terminal is Instagram, a selected element, among layout elements extracted by the layout feature extraction module 120, a lastly used feature, and a layout & content are analyzed using a feature detector “InstagramFeatureDetector” including a policy optimized for a feature provided from the Instagram to detect a detailed feature of the Instagram app which is being used by the user.

Particularly, the layout element based feature detection module 140 detects an element selected while traversing the layout element having a tree structure, analyzes the detected element to determine view information, analyzes a text associated with the view information to determine content information, and detects a currently in use feature based on a combination of the view information and the content information.

In the example embodiment of the present disclosure, the layout element based feature detection module 140 may determine the view information according to a position, a size, or index information of the selected element.

In the example embodiment of the present disclosure, the layout element based feature detection module 140 may determine the view information according to the class name of a root view for the selected element.

In the example embodiment of the present disclosure, the layout element based feature detection module 140 determines the view information according to the content description for the selected element and presence of the text.

In the example embodiment of the present disclosure, the layout element based feature detection module 140 may determine the view information according to viewIdResourceName information for the selected element.

The feature-level usage analysis module 150 analyzes the usage at the feature-level detected by the layout element based feature detection module 150 and displays the analyzed result to the user and induces a survey to the user.

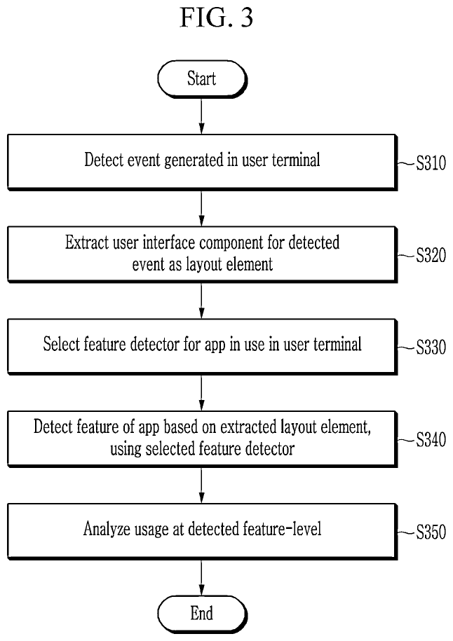

FIG. 3 is a flowchart for explaining a method for analyzing a feature-level usage of an app according to an example embodiment of the present disclosure.

Referring to FIG. 3, the method for analyzing a feature-level usage of an app according to an example embodiment of the present disclosure includes a step S310 of detecting an event generated in a user terminal, a step S320 of extracting a user interface component for the detected event as a layout element, a step S330 of selecting a feature detector for an app which is being used in the user terminal, a step S340 of detecting a feature of an app based on the extracted layout element using the selected feature detector, and a step S350 of analyzing the detected feature-level usage.

The method for analyzing a feature-level usage of an app may be described in more detail with reference to the description of the event detection module 110, the layout element extraction module 120, the feature detector selection module 130, the layout element based feature detection module 140, and the feature-level usage analysis module 150 which have been described above with reference to FIGS. 1 and 2 and a redundant description will be omitted.

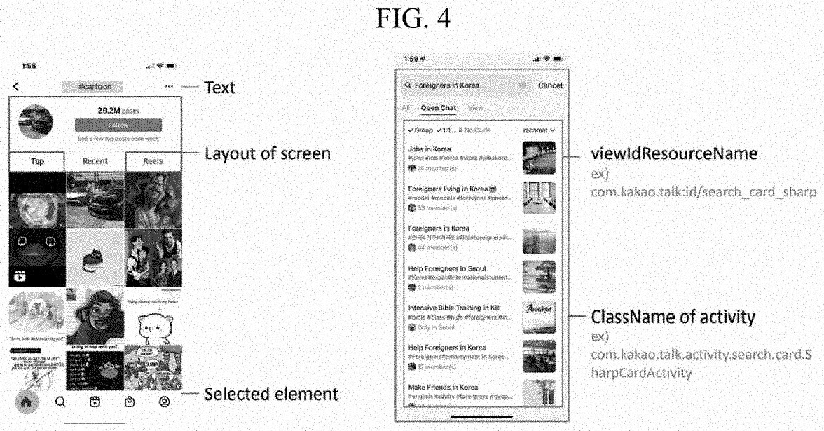

FIGS. 4 to 7 are views for explaining some example implementation examples of a device and a method for analyzing a feature-level usage of an app according to an example embodiment of the present disclosure.

Referring to FIG. 4, the layout element extraction module 120 extracts a layout of a screen including “graphicdesign”, popular posts, and recent posts” as texts, as a user interface component for the detected event and the selected element as a layout element. The feature detector selection module 130 selects “InstagramFeatureDetector” including a policy for the Instagram app and the layout element based feature detection module 140 may detect a feature which is current in use, for example, detect that the user is currently using a following feed feature based thereon.

Further, the layout element extraction module 120 extracts “ladder game” as a text, “com.kakao.talk:id/search_card_sharp” as viewIdResourceName, and “com.kakao.talk.activity.search.card.SharpCardActivity” which is a class name of the activity as a layout element, as a user interface component for the detected event. The feature detector selection module 130 selects “KakaoFeatureDetector” including a policy for the Kakao app and the layout element based feature detection module 140 may detect the feature which is currently in use, for example, detect that the user is currently using the game (ladder game) feature, based thereon.

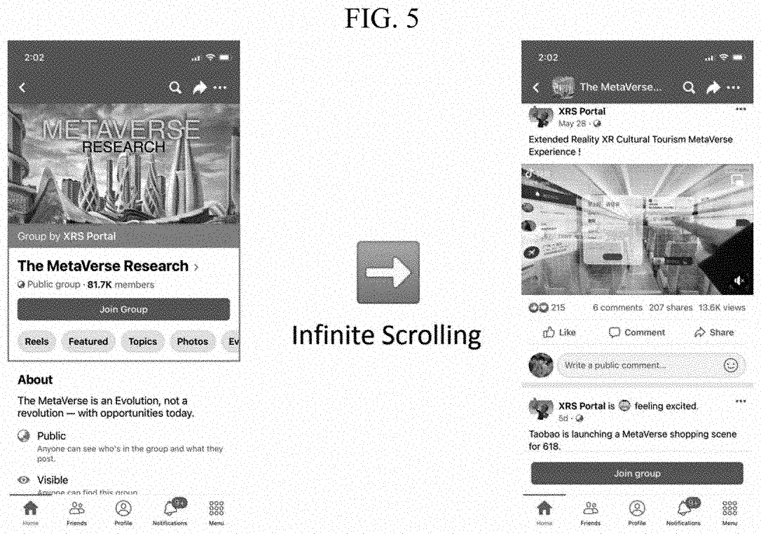

In the meantime, referring to FIG. 5, the layout element extraction module 120 extracts infinite scrolling as a layout element, as a user interface component for the detected event, the feature detector selection module 130 selects “FacebookFeatureDetector” including a policy for the Facebook app, and the layout element based feature detection module 140 may detect a currently in use feature, for example, detect that the user is using a feature of scrolling a newsfeed, based thereon.

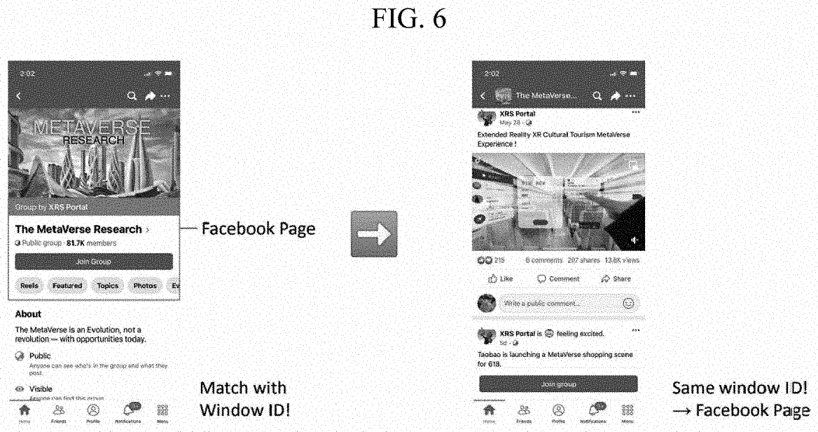

In the meantime, referring to FIG. 6, in order to prevent the interruption of the feature session due to the unexpected layout, an example that if the window ID is the same, determinest that the detected feature is also the same using a hash map of matching the detected feature and the window ID is illustrated.

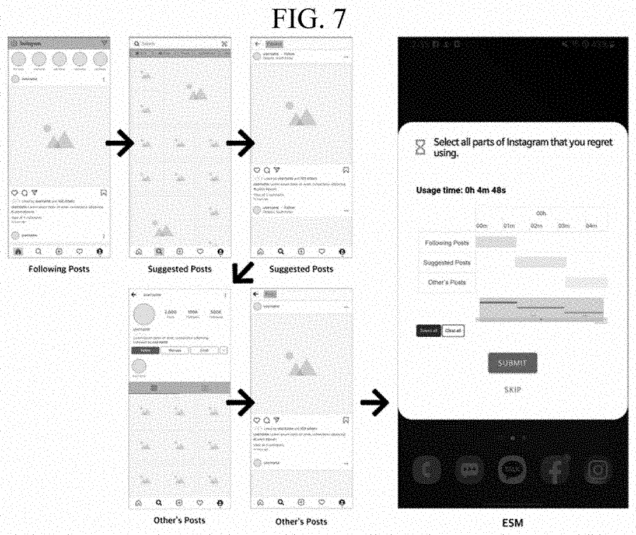

In the meantime, referring to FIG. 7, when the layout element based feature detection module 140 detects a following feed feature, a suggested post feature, and other's post feature, an example that induces a survey to the user while displaying a usage and a use pattern of the features on a graph is illustrated.

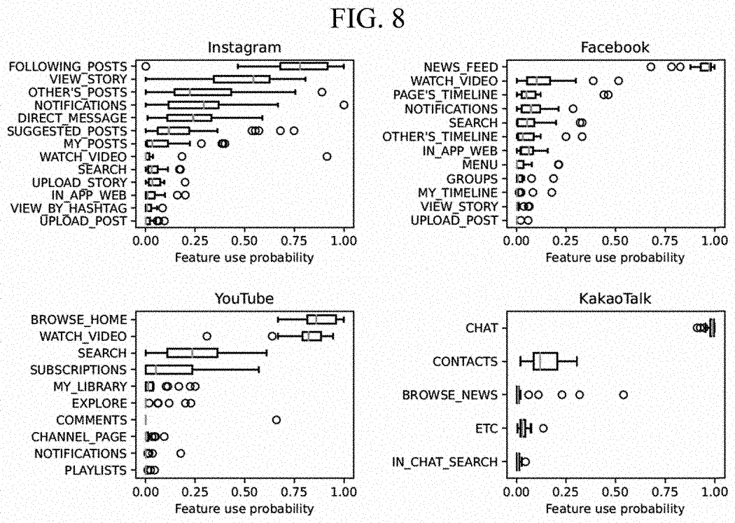

FIG. 8 is a view for explaining an example applied example of a device and a method for analyzing a feature-level usage of an app according to an example embodiment of the present disclosure.

Referring to FIG. 8, data which analyzes the feature-level usage may be used as various applications including prediction of feature use probability.

That is, the method and apparatus for analyzing a feature-level usage of an app according to the example embodiments of the present disclosure analyze the use of the smart phone at every feature-level, and the app usage or the use pattern may be decomposed into a “feature” usage or a sequence of a use pattern. For example, the Instagram session may be divided into sub features such as browsing the feed of following user's posts, browsing the feed of system-recommended posts, direct messaging, and viewing stories. Further, use of various app features is tracked using app layout information and the tracking result (usage or use pattern) is provided to the user or will be used for analysis or application later.

The method and apparatus for analyzing a feature-level usage of an app according to the example embodiments of the present disclosure have the following characteristics.
Criteria for features: a feature of a target application is extracted by a combination of two criteria of (1) a user action and (2) a nature of content. For example, the features are grouped based on user actions such as viewing, searching, uploading, and chatting. A nature of content includes a form of the content and a source of the content and examples of the form of the content include videos, feeds, notices, and posts and examples of the source of the content include user's posts, posts that the user follows, and the other user's posts that the user does not follow. The following example features may be defined in consideration of two criteria.

1) In case of KakaoTalk app:

| Feature name | Description |
|---|---|
| CONTACTS | viewing others' profile |
| CHAT | chatting with others |
| NEWS | reading news recommended by Kakaotalk |
| ETC | viewing a tab with various sub-features such as |
| | payment, emoticon shops, etc. |
| IN_CHAT_SEARCH | doing web search inside a chat room |

2) In case of YouTube app:

| Feature name | Description |
|---|---|
| BROWSE_HOME | viewing home tab with recommended videos |
| EXPLORE | viewing explore tab with trending videos |
| SUBSCRIPTIONS | viewing subscriptions tab with subscribing channels' |
| | videos |
| NOTIFICATIONS | checking notification |
| MY_LIBRARY | viewing library tab with recent, history, etc. |
| SEARCH | searching videos |
| CHANNEL_PAGE | viewing a channel's page |
| WATCH_VIDEO | watching videos |
| COMMENTS | reading comments |
| PLAYLISTS | exploring playlists |

3) In case of Instagram app:

| Feature name | Description |
|---|---|
| FOLLOWING_POSTS | viewing the feed with posts of the following |
| | users |
| SUGGESTED_POSTS | viewing the feed with posts recommended by |
| | Instagram |
| SEARCH | searching accounts, tags, places, etc. |
| NOTIFICATIONS | checking notification |
| MY_POSTS | viewing profile or posts of the user |
| OTHER'S_POSTS | viewing profile or posts of other users |
| DIRECT_MESSAGE | chatting with other users using direct message |
| VIEW_STORY | viewing Instagram story |
| UPLOAD_POST | uploading Instagram post |
| UPLOAD_STORY | uploading Instagram story |
| VIEW_BY_HASHTAG | viewing posts by hashtags |
| IN_APP_WEB | using Instagram web browser |
| WATCH_VIDEO | viewing videos |

4) In case of Facebook app:

| Feature name | Description |
|---|---|
| NEWS_FEED | viewing the Facebook news feed |
| GROUPS | viewing the posts from a group |
| WATCH_VIDEO | watching videos |
| MY_TIMELINE | viewing profile or posts of the user |
| OTHER'S_TIMELINE | viewing profile or posts of other users |
| NOTIFICATIONS | checking notification |
| MENU | exploring Facebook menu |
| PAGE'S_TIMELINE | viewing the posts from a page |
| MESSENGER | chatting with other users using Facebook |
| | messenger |
| SEARCH | searching accounts, tags, posts, etc |
| IN_APP_WEB | using Facebook web browser |
| VIEW_POST | viewing a post |
| COMMENTS | viewing comments of a post |
| VIEW_STORY | viewing Facebook story |
| UPLOAD_POST | uploading Facebook post |

Design and Implementation: a currently in use feature is detected using Android Accessibility API. UI constituent element information having a tree structure for all scroll, click, and focus events is searched. In order to detect the feature use, some of the information is selected and the element selected from the menu bar becomes a good indicator to represent the feature in use. Further, the layout information of each component is also used. Class names of the activity and the component provided by a developer are used to detect more complicated features and a window ID and a previously detected feature are used to analyze the use of various features in the session. Finally, hashed text data such as content description may be used for minimum use.
Personal information protection (Privacy): all screen information is monitored to detect the feature use so that a personal information protection issue needs to be considered. In the collected data, information about the contents of the screen or information exposing a subject should not be included, excluding the text information. Two types of text information including a text of the content and content description (a developer for a purpose of the UI element is added) may be used and in order to minimize the risk for the personal information, all text information is used with a hash format. Further, such information is used only to understand whether specific words or phrases are displayed on the screen. For example, whether the current feature is related to the viewing of posts is identified by identifying only whether the word “post” is present in the head using the hashed text.
Compatibility: the application is configured to consistently operate regardless of various screen sizes. For example, in order to detect the feature use, size information of the UI component may vary depending on the device so that the size information may not be utilized. Instead of that, a class name of the component which is set to be the same in all the devices may be mainly used. Then, pre-determined indicators are captured from the screen to detect the use of the feature. However, indicators for all combinations of the screen contents may not be defined in advance so that unspecified cases are labeled with undefined features. In this case, an undefined feature U is detected while using some pre-defined feature A, so that the pre-defined feature A may be falsely notified as closed. In order to prevent the unexpected interruption, a hash map matching the window ID having the detected feature A is used so that when the user views the screen with the same window ID, it is considered that the same feature A is still in use.

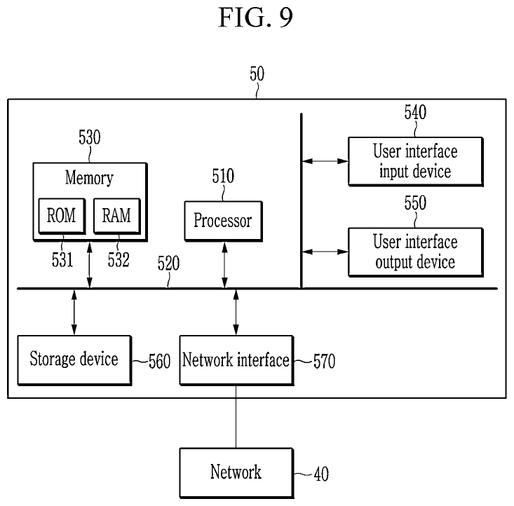

FIG. 9 is a block diagram for explaining a computing device for implementing a method and a device for analyzing a feature-level usage of an app according to an example embodiment of the present disclosure.

Referring to FIG. 9, a method and a device for analyzing a feature-level usage of an app according to an example embodiment of the present disclosure may be implemented using a computing device 50.

The computing device 50 may include at least one of a processor 510, a memory 530, a user interface input device 540, a user interface output device 550, and a storage device 560 which communicate with each other via a bus 520. The computing device 50 may include a network interface 570 which is electrically connected to the network 40, for example, a wireless network. The network interface 570 may transmit or receive a signal with the other entity via the network 40.

The processor 510 may be an application processor (AP) or a central processing unit (CPU) or an arbitrary semiconductor device which executes instructions stored in the memory 530 or the storage device 560. The processor 510 may be configured to implement the features and methods described above with regard to FIGS. 1 to 8.

The memory 530 and the storage device 560 may include various types of volatile or non-volatile storage media. For example, the memory includes a read-only memory (ROM) 531 and a random access memory (RAM) 532. In the example embodiment of the present disclosure, the memory 530 may be located inside or outside the processor 510 and the memory 530 may be connected to the processor 510 by means of various known means.

Further, at least some of the features of the device for analyzing a feature-level usage of an app according to the example embodiment of the present disclosure may be implemented as programs or software which is executed in the computing device 50 and the programs or software is stored in a computer readable medium.

Further, at least some of the features of the device for analyzing a feature-level usage of an app according to the example embodiment of the present disclosure may be implemented as hardware which is electrically connected to the computing device 50.

According to the example embodiment of the present disclosure which has been described so far, a usage, a use form, or a use pattern of the smart phone is analyzed at a feature level of the app to analyze which app is used by the user for a long time and which app is frequently used in the app-unit analysis of the related art. Further, even in one app, which feature is spent a lot of time by the user and which feature is frequently used are also specifically analyzed. Simultaneously, when the data for the analysis is collected, the personal information protection issue may not be caused.

Further, according to the example embodiment of the present disclosure, such detailed analysis is executed as a background service without going through an artificial analysis process by experts to automatically collect a usage, a use form, or a use pattern of a smart phone to ensure the reliable analysis data in a short time.

Further, according to the example embodiment of the present disclosure, since an interface which is capable of customizing a feature-level of an app to be analyzed is provided to a developer or an analyzer, when an app which is newly used is analyzed in the feature level, the method and the device for analyzing a feature-level of an app may easily set the analysis policy without going through complicated coding tasks so that the usability may be increased and the usage convenience may be ensured.

While this disclosure has been described in connection with what is presently considered to be practical example embodiments, it is to be understood that the disclosure is not limited to the disclosed embodiments. On the contrary, it is intended to cover various modifications and equivalent arrangements included within the spirit and scope of the appended claims.

What is claimed is:

1. A method for analyzing feature-level usage of an app, comprising:
detecting an event generated in a user terminal;
extracting a user interface component for the detected event as a layout element;
detecting a feature of the app based on the extracted layout element; and
analyzing a usage at the detected feature-level.

2. The method of claim 1, further comprising:
selecting a feature detector for an app in use in the user terminal,
wherein detecting the feature of the app includes:
detecting the feature of the app using the selected feature detector.

3. The method of claim 2, wherein:
the app includes a first app and a second app, and
selecting a feature detector includes:
ending the use of a feature detector for the first app and starting the use of a feature detector for the second app when a session of the first app ends and a session of the second app starts.

4. The method of claim 1, wherein extracting a user interface component for the detected event as a layout element includes:
storing information about the user interface component as the layout element with a tree structure.

5. The method of claim 4, wherein detecting the feature of the app includes:
detecting an element selected while traversing the layout element with the tree structure;
determining view information by analyzing the element;
determining content information by analyzing a text associated with view information; and
detecting the feature based on a combination of the view information and the content information.

6. The method of claim 5, wherein determining view information includes:
determining the view information according to a location, a size or index information of the selected element.

7. The method of claim 5, wherein: determining view information includes:
determining view information according to a class name of a root view for the selected element.

8. The method of claim 5, wherein determining view information includes:
determining the view information according to whether there are content description and a text for the selected element.

9. The method of claim 5, wherein determining view information includes:
determining the view information according to viewIdResourceName information for the selected element.

10. The method of claim 1, wherein detecting an event includes:
detecting at least one of a scroll event, a click event, a focus event, a window transition event, and a window state transition event.

11. A device for analyzing feature-level usage of an app, comprising:
an event detection module which detects an event generated in a user terminal;
a layout element extraction module which extracts a user interface component for the detected event as a layout element;
a layout element based feature detection module which detects a feature of the app based on the extracted layout element; and
a feature-level usage analysis module which analyzes a usage at the detected feature level.

12. The device of claim 11, further comprising:
a feature detector selection module which selects a feature detector for an app in use in the user terminal,
wherein the layout element based feature detection module detects the feature of the app using the selected feature detector.

13. The device of claim 12, wherein the app includes a first app and a second app, and
the feature detector selection module ends the use of a feature detector for the first app and starts the use of a feature detector for the second app when a session of the first app ends and a session of the second app starts.

14. The device of claim 11, wherein the layout element extraction module stores information about the user interface component as the layout element with a tree structure.

15. The device of claim 14, wherein the layout element based feature detection module detects an element selected while traversing the layout element with the tree structure, determines view information by analyzing the element, determines content information by analyzing a text associated with view information, and detects the feature based on a combination of the view information and the content information.

16. The device of claim 15, wherein the layout element based feature detection module determines the view information according to a location, a size or index information of the selected element.

17. The device of claim 15, wherein the layout element based feature detection module determines view information according to a class name of a root view for the selected element.

18. The device of claim 15, wherein the layout element based feature detection module determines the view information according to whether there are content description and a text for the selected element.

19. The device of claim 15, wherein the layout element based feature detection module determines the view information according to viewIdResourceName information for the selected element.

20. The device of claim 11, wherein the event detection module detects at least one of a scroll event, a click event, a focus event, a window transition event, and a window state transition event.
